(19) United States
(12) Patent Application Publication
(10) Pub. No.: US 2012/0173011 A1
(43) Pub. Date: Jul. 5, 2012

(54) Implementation of Transmission and Control Platform for Equipment Front End Module of Semiconductor Production System

(75) Inventors: Haibin YU, Liaoning (CN); Aidong XU, Liaoning (CN); Jilong ZHANG, Liaoning (CN); Mingzhe LIU, Liaoning (CN); Jingtao HU, Liaoning (CN); Zheng LI, Liaoning (CN)

(73) Assignee: Shenyang Institute of Automation, Chinese Academy of Sciences, Liaoning (CN)

(21) Appl. No.: 13/072,791

(22) Filed: Mar. 28, 2011

(30) Foreign Application Priority Data
Dec. 31, 2010 (CN) 201010616602.1

(51) Int. Cl. G06F 19/00

(52) U.S. Cl. 700/121

(57) ABSTRACT

A method of platformization of an equipment front end module of a semiconductor production system includes the steps of: establishing a subsystem management module, a communication interface module, a parse module, and a network communication module; directing the command by the communication interface module to the subsystem management module; analyzing the command by the subsystem management module and sending the command to the corresponding subsystem module; sending the command from the corresponding subsystem module to the controller of the equipment front end module through the network communication module; and analyzing message by the parse module, sending a feedback to the corresponding subsystem module, and then sending the feedback to the control system of the semiconductor production system through the communication interface module. The present invention provides a standardized software interface to standardize different IC equipment control systems and to enhance the production efficiency of the system.

### BACKGROUND OF THE PRESENT INVENTION

1. Field of Invention

The present invention relates to a platform of control system, and more particularly to an implementation of transmission and control platform for equipment front end module of a semiconductor production system.

2. Description of Related Arts

An Equipment Front End Module (EFEM) is the mainstay of semiconductor loading and delivering tool, especially for silicon wafers. The Equipment Front End Module generally comprises a plurality of front opening unified pods (FOUP) for securely holding silicon wafers in a controlled environment, a robot arm, an alignment unit, and a clean environmental controller, wherein the Equipment Front End Module is considered as a key component for the semiconductor manufacturing process as a distributed control system to deliver the semiconductor between ultra-clean storage carriers and processing systems.

Accordingly, different manufacturers of the Equipment Front End Module have different communication protocols. In particular, different models of the Equipment Front End Module also have different communication protocols. In other words, it is troublesome for the device integration manufacturers that the control software must be renewed or re-installed at the time during the replacement of the Equipment Front End Module for the semiconductor production system. In addition, there is no unified command for the system, such that the semiconductor production process will be substantially slowed down due to the implementation of the Equipment Front End Module. Therefore, the production line of the semiconductor cannot be fully unitized without the fully compatibility of the Equipment Front End Module.

Since there is general software for the Equipment Front End Module in the market, stratification of the common characteristics is the only way to unite different devices from different manufacturers. In other words, it is important to establish a unified and compatible control platform for the Equipment Front End Module of the semiconductor production system.

### SUMMARY OF THE PRESENT INVENTION

The invention is advantageous in that it provides a transmission and control platform for an equipment front end module of a semiconductor production system to establish a unified and compatible control platform for controlling the equipment front end module of the semiconductor production system. In other words, the present invention provides a universal communication link between the controller of the equipment front end module and the control system of the semiconductor production system.

Additional advantages and features of the invention will become apparent from the description which follows, and may be realized by means of the instrumentalities and combinations particular point out in the appended claims.

According to the present invention, the foregoing and other objects and advantages are attained by a method of platformization of an equipment front end module of a semiconductor production system via a transmission and control platform, comprising the steps of:

establishing a subsystem management module, a communication interface module communicatively linked to a plurality of subsystem modules, a parse module, and a network communication module in responsive to characteristics of a plurality of equipment front end modules of a semiconductor production system from different manufacturers;

directing the command by the communication interface module to the subsystem management module, when the communication interface module receives a command sent from the control system of the semiconductor production system;

analyzing the command by the subsystem management module and sending the command to the corresponding subsystem module;

based on the currently state, sending the command from the corresponding subsystem module to the controller of the equipment front end module through the network communication module; and

analyzing message, sent from the controller of the equipment front end module through the network communication module, by the parse module, sending a feedback to the corresponding subsystem module, and then sending the feedback to the control system of the semiconductor production system through the communication interface module.

The above step of establishing the subsystem management module comprises the sub-steps of:

generating a plurality of subsystem modules for the characteristics of the equipment front end modules respectively;

generating a plurality of command table for each of the subsystem modules;

generating a subsystem module table by the selected subsystem modules corresponding to the equipment front end module being used by the end user, and then the subsystem management module is generated in responsive to the subsystem module table corresponding to the equipment front end module being used by the end user. In other words, once the corresponding equipment front end module is selected to be used for the semiconductor production system, the subsystem management module can be formed in responsive to the selected subsystem management module.

A command terminal is formed to receive command and transmit feedback of the equipment front end module of the semiconductor production system based on the communication interface module in responsive to the characteristics of the control system of the semiconductor production system.

The above step of establishing the parse module comprises the sub-steps of:

establishing an analysis manual based on the protocol of the equipment front end module of the corresponding manufacturer;

based on the analysis manual, communicatively linking between the controller of the equipment front end module and the subsystem modules to effectively transmit command and information therebetween.

The network communication module is communicatively linked to the controller of the equipment front end module in order to send the synthetic command string to the controller of the equipment front end module and to monitor the feedback therefrom.

The subsystem management module will analyze the command and will send the command to the corresponding subsystem module. Based on the currently state, the corresponding subsystem module will perform an appropriate action according to the command and send a corresponding command to the controller of the equipment front end module through the network communication module. It is worth mentioning that two or more subsystem modules can be executed at the same time to perform appropriate actions and send multiple commands to the controller of the equipment front end module through the network communication module. Accordingly, the receiving and transmitting command comprises the steps of:

when the subsystem management module receives the command, searching the command code in the command tables;

determining whether the command matching with the command code in the command tables;

if the command matches with the command code in the command tables, sending the command to the corresponding subsystem module;

determining whether the corresponding subsystem module at an idle status;

if the corresponding subsystem module is at the idle status, synthesizing a synthetic command string for sending to the controller of the equipment front end module by the bi-directional command conversion map through the subsystem command tables;

sending the synthetic command string to the controller of the equipment front end module through the network communication module, At the same time, recording the command sent from the corresponding subsystem module to end the control process;

distributing the commands by the subsystem management module to the corresponding subsystem modules respectively and continuously monitoring and distributing the command to other subsystem modules, such that the subsystem management module can manage and parallelly schedule the subsystem modules;

if the corresponding subsystem module is not at the idle status, sending a status disqualified error back to the control system of the semiconductor production system through the communication interface module, and returning back to the system management module to receive another command from the control system of the semiconductor production system;

if the command does not match with the command code in the command tables, sending a command parameter error back to the control system of the semiconductor production system through the communication interface module, and returning back to the system management module to receive another command from the control system of the semiconductor production system.

The synthetic command string is formed using the bi-directional command conversion map by the steps of:

establishing a forward command conversion map between the control command parameters of the control system of the semiconductor production system and the control command parameters of the controller of the equipment front end module;

establishing a reverse command conversion map between the control command parameters of the controller of the equipment front end module and the control command parameters of the control system of the semiconductor production system;

in responsive to the command received by the subsystem management module, searching the corresponding control command parameter of the controller of the equipment front end module through the forward command conversion map;

generating the synthetic command string for sending to the controller of the equipment front end module synthesizing the command and the found control command parameter at the forward command conversion map.

The parse module will analyze message sent from the controller of the equipment front end module through the network communication module, wherein a feedback will be sent to the corresponding subsystem module, and then to the control system of the semiconductor production system through the communication interface module. The method of generating the feedback comprises the steps of:

receiving and analyzing a feedback query by the parse module, wherein the feedback query is sent from the controller of the equipment front end module through the network communication module;

sending the feedback query to the subsystem management module after analysis, wherein the subsystem management module will search the corresponding subsystem modules in the subsystem module tables to find the corresponding subsystem modules at the status waiting for the feedback result;

determining the corresponding subsystem module in responsive to the command and setting the corresponding subsystem module at the idle status;

sending the feedback to the control system of the semiconductor production system through the communication interface module.

Accordingly, the present invention has the following advantages.

(1) The present invention is designed for the equipment front end module of the semiconductor production system in order to provide a standardized software interface so as to standardize different IC equipment control systems, to control the operation of the mechanisms in parallel via the execution of command, and to enhance the production efficiency of the system.

(2) The present invention utilize the modular design method to rapidly form a transmission and control system for the different structural configurations of equipment front end module of the semiconductor production system made by different manufacturers, wherein the present invention can substantially shorten the development cycle and cost in order to link to the equipment front end module. In other words, the present invention ensures the initial setup of the equipment front end module in advance to the production of semiconductor. In addition, the modular design method will provide a flexible configuration of the equipment front end module according to the need of the end user and will enhance the compatibility of the equipment front end module.

(3) The present invention provides a bi-directional command conversion map to achieve the conversion between the control command parameters of the control system of the semiconductor production system and the control command parameters of the controller of the equipment front end module, so as to ensure the unity of the system interface.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a transmission and control platform for equipment front end module of a semiconductor production system according to a preferred embodiment of the present invention.

FIG. 2 is a flow diagram illustrating the receiving and transmitting directions of a command according to the above preferred embodiment of the present invention.

FIG. 3 is a schematic diagram illustrating the bi-directional command conversion map according to the above preferred embodiment of the present invention.

FIG. 4 is a flow diagram illustrating the feedback result according to the above preferred embodiment of the present invention.

### DETAILED DESCRIPTION OF THE PREFERRED EMBODIMENT

Referring to all the drawings, an implementation of transmission and control platform for equipment front end module of a semiconductor production system according to a preferred embodiment of the present invention is illustrated, wherein the implementation method comprises the following steps.

(1) Establish a subsystem management module, a communication interface module, a parse module, and a network communication module in responsive to a plurality of equipment front end modules of a semiconductor production system from different manufacturers.

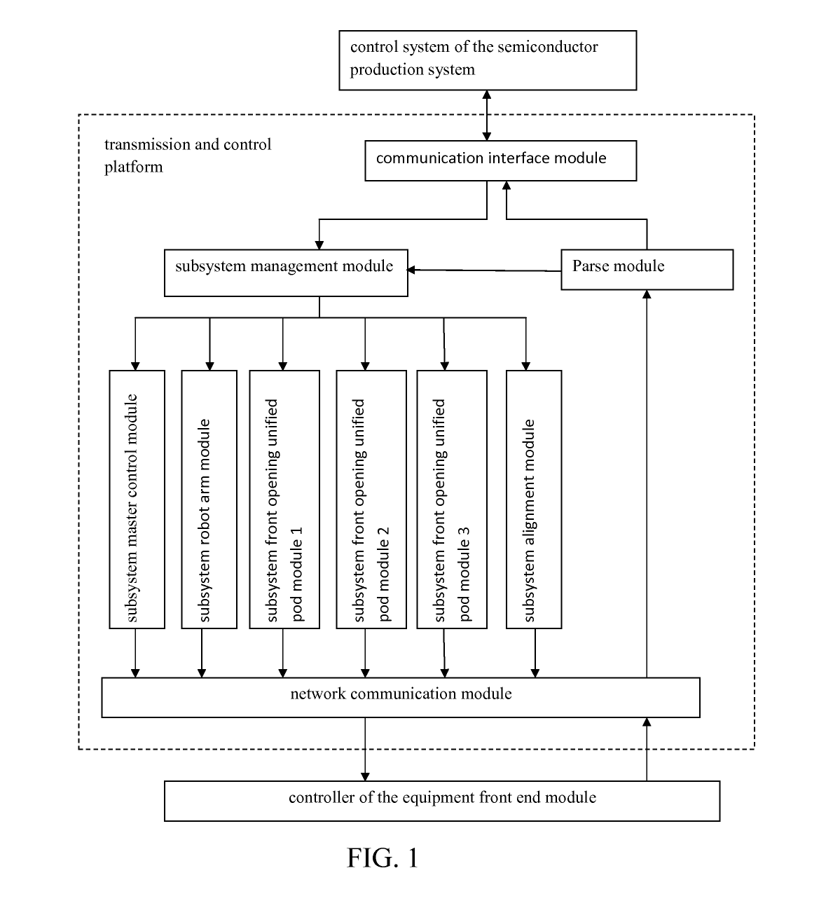

As shown in FIG. 1, a transmission and control platform for the equipment front end module of the semiconductor production system is illustrated. The transmission and control platform comprises a plurality of subsystem modules which are embodied as a subsystem master control module, a subsystem robot arm module, three subsystem front opening unified pod modules, and a subsystem alignment module respectively, wherein each module has its own command table.

Based on each of the selected subsystem modules, a corresponding subsystem module table is generated to form the subsystem management module.

The communication interface module, preferably using socket based network communication protocols, forms command terminal to receive command and transmit feedback of the equipment front end module of the semiconductor production system.

The parse module is arranged to establish an analysis manual based on the protocol of the equipment front end module of the corresponding manufacturer, wherein the parse module is communicatively linked between the controller of the equipment front end module and the subsystem modules to effectively transmit command and information therebetween.

The network communication module, preferably based on TCP/IP network protocol, is arranged to establish data connection, data close connection, data sending function, and data receiving function.

The transmission and control platform is communicatively linked to the control system of the semiconductor production system through the communication interface module. The subsystem modules and the parse module are communicatively linked to the controller of the equipment front end module.

(2) When the communication interface module receives a command sent from the control system of the semiconductor production system, the communication interface module will direct the command to the subsystem management module. The subsystem management module will analyze the command and will send the command to the corresponding subsystem module. Based on the currently state, the corresponding subsystem module will send the command to the controller of the equipment front end module through the network communication module. It is worth mentioning that two or more subsystem modules can be executed at the same time to perform appropriate actions and send multiple commands to the controller of the equipment front end module through the network communication module.

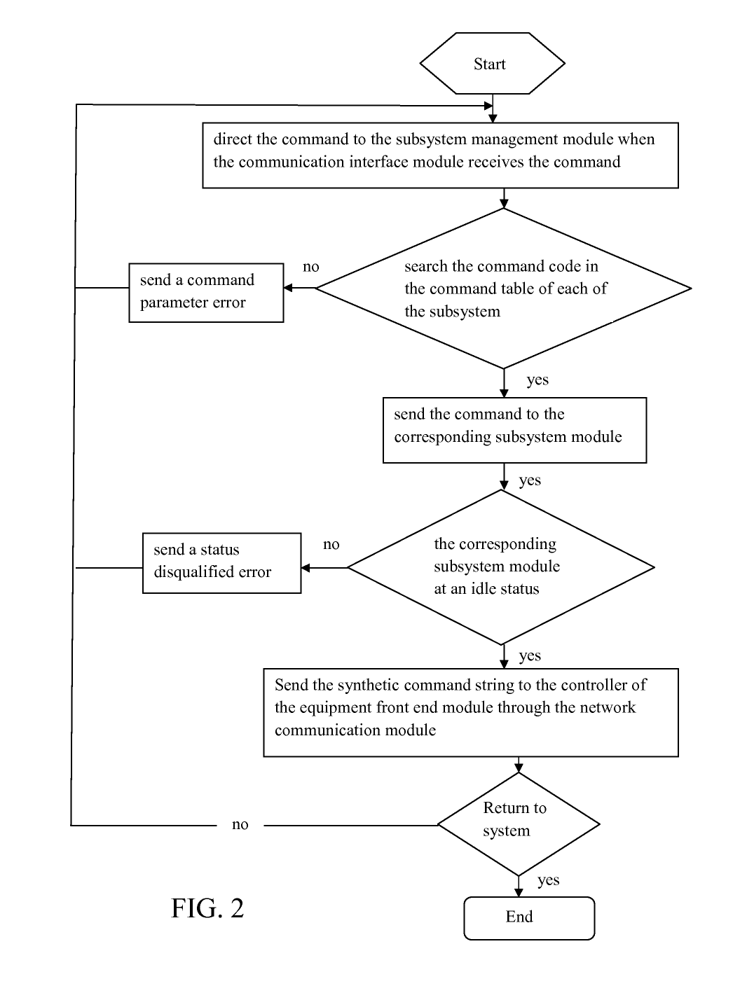

FIG. 2 illustrates the flow diagram of the receiving and transmitting command Accordingly, the receiving and transmitting command comprises the following steps.

When the communication interface module receives a command sent from the control system of the semiconductor production system, direct the command from the communication interface module to the subsystem management module.

When the subsystem management module receives the command, search the command code in the command table.

Determine whether the command matching with the command code in the command table.

If the command matches with the command code in the command table, send the command to the corresponding subsystem module.

If the command does not match with the command code in the command table, send a command parameter error back to the control system of the semiconductor production system through the communication interface module, and return back to the system management module to receive another command from the control system of the semiconductor production system.

Determine whether the corresponding subsystem module at an idle status.

If the corresponding subsystem module is at the idle status, send a synthetic to command string formed by using the bi-directional command conversion map through the subsystem command table to the controller of the equipment front end module through the network communication module.

If the corresponding subsystem module is not at the idle status, send a status disqualified error back to the control system of the semiconductor production system through the communication interface module, and return back to the system management module to receive another command from the control system of the semiconductor production system.

Send the synthetic command string to the controller of the equipment front end module through the network communication module. At the same time, record the command sent from the corresponding subsystem module to end the control process.

The subsystem management module will distribute the commands to the corresponding subsystem modules respectively and will continuously monitor and distribute the command to other subsystem modules such that the subsystem management module can manage and parallelly schedule the subsystem modules.

(3) Generate the synthetic command string formed by the bi-directional command conversion map to be sent to the controller of the equipment front end module ultimately.

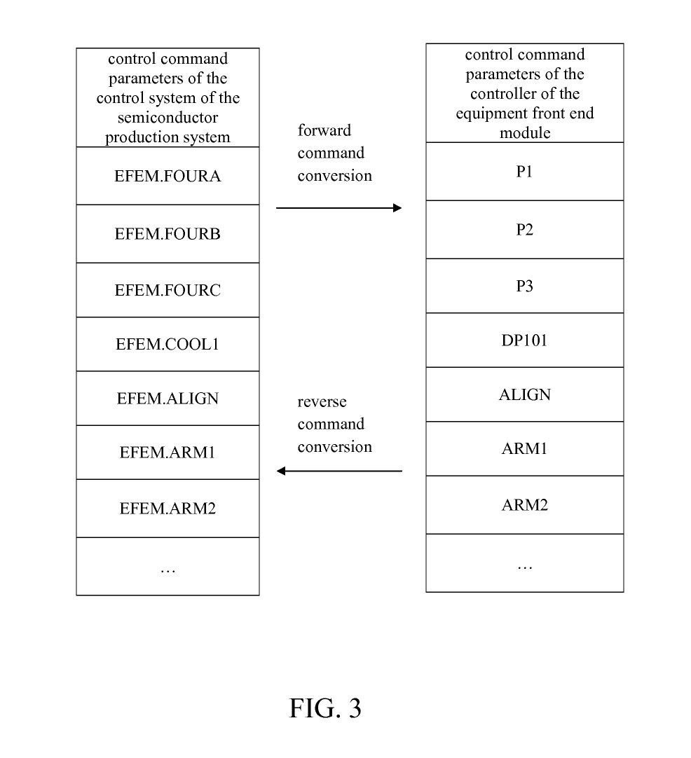

FIG. 3 illustrates the bi-directional command conversion map. Accordingly, the control command parameters of the control system of the semiconductor production system include EFEM.FOURA, EFEM.FOURB, EFEM.FOURC, EFEM.COOL, EFEM.ALIGN, EFEM.ARM1, EFEM.ARM2, etc, which are associated with the control command parameters of the controller of the equipment front end module including P1, P2, P3, DP101, ALIGN, ARM1, ARM2, etc. The command conversion comprises the following steps.

Establish a forward command conversion map between the control command parameters of the control system of the semiconductor production system and the control command parameters of the controller of the equipment front end module.

Establish a reverse command conversion map between the control command parameters of the controller of the equipment front end module and the control command parameters of the control system of the semiconductor production system.

In responsive to the command received by the subsystem management module, search the corresponding the control command parameter of the controller of the equipment front end module through the forward command conversion map.

Generate the synthetic command string for sending to the controller of the equipment front end module by synthesizing the command and the found control command parameter at the forward command conversion map.

(4) Analyze message, sent from the controller of the equipment front end module through the network communication module, by the parse module, send a feedback to the corresponding subsystem module, and then send the feedback to the control system of the semiconductor production system through the communication interface module.

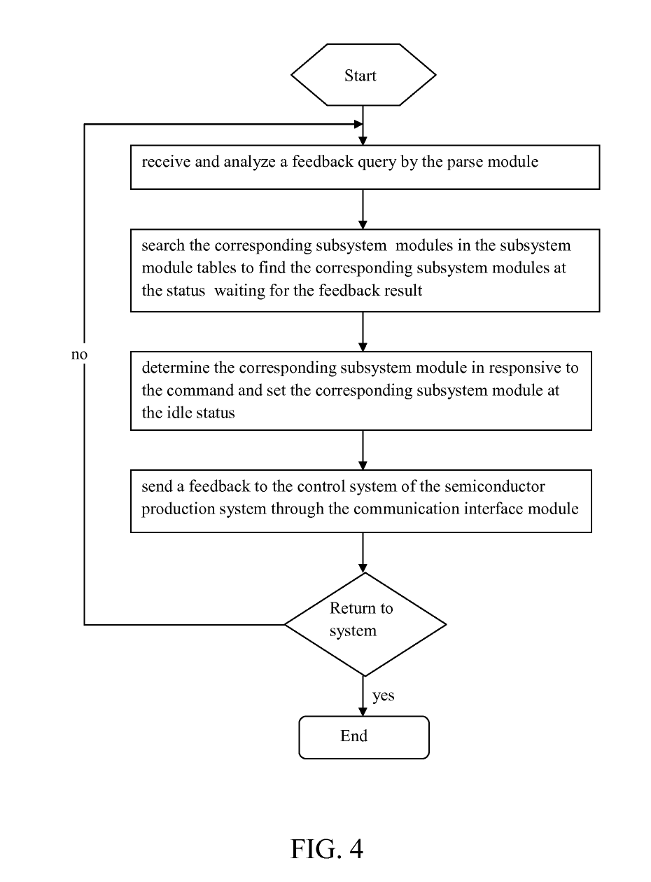

FIG. 4 illustrates the flow diagram of the feedback which comprises the following steps.

Receive and analyze a feedback query by the parse module, wherein the feedback query is sent from the controller of the equipment front end module through the network communication module.

Send the feedback query to the subsystem management module after analysis, wherein the subsystem management module will search the corresponding subsystem modules in the subsystem module tables to find the corresponding subsystem modudels at the status waiting for the feedback result.

Determine the corresponding subsystem modules in responsive to the command and set the corresponding subsystem modules at the idle status.

Send a corresponding feedback to the control system of the semiconductor production system through the communication interface module.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of platformization of an equipment front end module of a semiconductor production system, comprising the steps of:
(a) establishing a subsystem management module communicating linked to a plurality of subsystem modules, a communication interface module, a parse module, and a network communication module in responsive to characteristics of a plurality of equipment front end modules of a semiconductor production system from different manufacturers;
(b) directing a command by said communication interface module to said subsystem management module when said communication interface module receives said command sent from a control system of said semiconductor production system;
(c) analyzing said command by said subsystem management module and sending said command to said corresponding subsystem module, wherein based on the currently state, said command is sent from said corresponding subsystem module to a controller of said equipment front end module through said network communication module; and
(d) analyzing message, which is sent from said controller of said equipment front end module through said network communication module, by said parse module, sending a feedback to said corresponding subsystem module, and then sending said feedback to said control system of said semiconductor production system through said communication interface module.

2. The method, as recited in claim 1, wherein said subsystem management module is established by the steps of:
generating a plurality of subsystem modules for the characteristics of said equipment front end modules respectively and generating a plurality of command tables for said subsystem modules; and
generating a subsystem module table by said subsystem modules corresponding to said equipment front end module selected by an end user and generating said subsystem management module in responsive to said subsystem module table.

3. The method, as recited in claim 1, wherein a command terminal is formed to receive said command and transmit said feedback of said equipment front end module of said semiconductor production system based on said communication interface module in responsive to the characteristics of said control system of said semiconductor production system.

4. The method, as recited in claim 1, wherein said parse module is established by the steps of:
establishing an analysis manual based on a protocol of said equipment front end module of said corresponding manufacturer; and
based on said analysis manual, communicatively linking between said controller of said equipment front end module and said subsystem modules to effectively transmit command and information therebetween.

5. The method, as recited in claim 1, wherein said network communication module is communicatively linked to said controller of the equipment front end module in order to send a synthetic command string to said controller of the equipment front end module and to monitor said feedback therefrom.

6. The method, as recited in claim 1, wherein said subsystem management module analyzes said command and send said command to said corresponding subsystem module, wherein based on a currently state, said corresponding subsystem module perform an appropriate action according to said command and sends said command to said controller of said equipment front end module through said network communication module, wherein two or more of said subsystem modules are able to be executed at the same time to perform appropriate actions and send multiple commands to said controller of said equipment front end module through said network communication module, wherein said receiving and transmitting command comprises the steps of:
when said subsystem management module receives said command, searching a command code in a command table;
determining whether said command matching with said command code in said command table;
if said command matches with said command code in said command table, sending said command to said corresponding subsystem module;
determining whether said corresponding subsystem module at an idle status;
if said corresponding subsystem module is at said idle status, synthesizing a synthetic command string for sending to said controller of said equipment front end module by a bi-directional command conversion map through said subsystem command table;
sending said synthetic command string to said controller of the equipment front end module through said network communication module, and at the same time, recording said command sent from said corresponding subsystem module to end a control process; and
distributing said commands by said subsystem management module to said corresponding subsystem modules respectively and continuously monitoring and distributing said command to other said subsystem modules, such that said subsystem management module is adapted to manage and parallelly schedule said subsystem modules.

7. The method, as recited in claim 6, wherein said receiving and transmitting command further comprises the steps of:
if said corresponding subsystem module is not at the idle status, sending a status disqualified error back to said control system of said semiconductor production system through said communication interface module, and returning back to said system management module to receive another command from said control system of said semiconductor production system.

8. The method, as recited in claim 6, wherein said receiving and transmitting command further comprises the steps of:
if said command does not match with said command code in said command table, sending a command parameter error back to said control system of said semiconductor production system through said communication interface module, and returning back to said system management module to receive another command from said control system of said semiconductor production system.

9. The method, as recited in claim 6, wherein said synthetic command string is formed using said bi-directional command conversion map by the steps of:
establishing a forward command conversion map between control command parameters of the control system of said semiconductor production system and control command parameters of said controller of said equipment front end module;
establishing a reverse command conversion map between said control command parameters of said controller of the equipment front end module and said control command parameters of said control system of said semiconductor production system;
in responsive to said command received by said subsystem management module, searching said corresponding control command parameter of said controller of said equipment front end module through said forward command conversion map; and
generating said synthetic command string for sending to said controller of said equipment front end module by synthesizing said command and said found control command parameter at said forward command conversion map.

10. The method, as recited in claim 1, wherein said parse module analyzes said message sent from said controller of said equipment front end module through said network communication module, wherein said feedback is sent to said corresponding subsystem module, and then to said control system of said semiconductor production system through said communication interface module, wherein said feedback is generated by the steps of:
sending a feedback query to said subsystem management module after analysis, wherein said subsystem management module searches corresponding subsystem modules in the subsystem module tables to find the corresponding subsystem modules at the status waiting for a feedback result;
determining said corresponding subsystem module in responsive to said command and setting said corresponding subsystem module at an idle status; and
sending said feedback to said control system of said semiconductor production system through said communication interface module.
